(19) United States
(12) Patent Application Publication
(10) Pub. No.: US 2012/0115039 A1
(43) Pub. Date: May 10, 2012

(54) All Solid Secondary Battery and Manufacturing Method Therefor

(75) Inventors: Masutaka Ouchi, Kyoto-Fu (JP); Koichi Watanabe, Kyoto-fu (JP); Kunio Nishida, Kyoto-Fu (JP); Hitomi Nishida, Nagaokakyo-shi (JP); Takafumi Inaguchi, Nagaokakyo-shi (JP)

(73) Assignee: Murata Manufacturing Co., Ltd.

(21) Appl. No.: 13/352,635

(22) Filed: Jan. 18, 2012

Related U.S. Application Data
(63) Continuation of application No. PCT/JP2011/059486, filed on Apr. 18, 2011.

(30) Foreign Application Priority Data
Apr. 23, 2010 (JP) 2010-099332

(51) Int. Cl. H01M 10/0562; H01M 10/04

(52) U.S. Cl. 429/304; 156/242

(57) ABSTRACT

A solid secondary battery that includes a positive electrode layer, a solid electrolyte layer including an oxide-based solid electrolyte, and a negative electrode layer. At least one of the positive electrode layer and the negative electrode layer, and the solid electrolyte layer are joined by sintering. At least one of the positive electrode layer and the negative electrode layer includes an electrode active material, and a conductive agent containing a carbon material, and the conductive agent includes a carbon material which has a specific surface area of 1000 m²/g or less.

### CROSS REFERENCE TO RELATED APPLICATIONS

The present application is a continuation of International application No. PCT/JP2011/059486, filed Apr. 18, 2011, which claims priority to Japanese Patent Application No. 2010-099332, filed Apr. 23, 2010, the entire contents of each of which are incorporated herein by reference.

### FIELD OF THE INVENTION

The present invention generally relates to an all solid secondary battery and a method for manufacturing the all solid secondary battery, and more particularly, relates to an all solid secondary battery including a positive electrode layer, a solid electrolyte layer including an oxide-based solid electrolyte, and a negative electrode layer, with at least one of the positive electrode layer and the negative electrode layer, and the solid electrolyte layer joined by sintering, and a method for manufacturing the all solid secondary battery.

### BACKGROUND OF THE INVENTION

In recent years, batteries, in particular, secondary batteries have been used as main power supplies of portable electronic devices such as cellular phones and portable personal computers, backup power supplies, power supplies for hybrid electric vehicles (HEV), etc. Among secondary batteries, rechargeable lithium ion secondary batteries have been used which have a high energy density.

In these lithium ion secondary batteries, an organic electrolyte (electrolytic solution) of a lithium salt dissolved in a carbonate ester or ether based organic solvent, or the like have been used conventionally as a medium for transferring ions.

However, the lithium ion secondary batteries described above are at risk of causing the electrolytic solution to leak out. In addition, the organic solvent or the like for use in the electrolytic solution is a flammable material. For this reason, there has been a need to further increase the safety of batteries.

Therefore, in order to increase the safety of lithium ion secondary batteries, the use of a solid electrolyte as the electrolyte has been proposed in place of the organic solvent based electrolytic solution. In particular, compounds which have a NASICON structure are ion conductors which can conduct lithium ions at high speed, and the development of all solid secondary batteries using this type of compound as a solid electrolyte has been thus advanced.

For example, Japanese Patent Application Laid-Open No. 2007-258148 (hereinafter, referred to as Patent Document 1) proposes an all solid secondary battery which is all composed of solid components with the use of a nonflammable solid electrolyte. As an example of this all solid secondary battery, a laminate-type solid battery is described which has electrode layers (a positive electrode layer, a negative electrode layer) and a solid electrolyte layer joined by sintering. An active material is mixed with acetylene black as a conductive agent to prepare an electrode paste, and the electrode paste is applied by screen printing onto both surfaces of a solid electrolyte, and then subjected to firing at a temperature of 700° C. to prepare a laminated body for a solid battery.

Patent Document 1: Japanese Patent Application Laid-Open No. 2007-258148

### SUMMARY OF THE INVENTION

However, the inventors have found, in the manufacturing method described in Patent Document 1, a problem that when an active material is mixed with acetylene black as a conductive agent to prepare an electrode paste, the carbon material is burned to reduce the effect of providing the electrode layer with electron conductivity, thereby making it impossible to make full use of the active material in the electrode layer, in a step of burning and thus removing organic matters (for example, a binder, a dispersant, a plasticizer, etc.) in a slurry.

Therefore, an object of the present invention is to provide an all solid secondary battery which is, even in the case of using an electrode material obtained by adding a carbon material as a conductive agent to an electrode active material, and joining an electrode layer and a solid electrolyte layer by sintering, capable of achieving the full effect of the conductive agent providing the electrode layer with electron conductivity, and a method for manufacturing the all solid secondary battery.

The inventors have found, as a result of earnest consideration for solving the problem mentioned above, that the use of a carbon material with a small specific surface area as a conductive agent makes the conductive agent remain even after the removal of a binder, thereby making it possible to maintain the electron conductivity. The present invention has been achieved on the basis of this finding, and has the following features.

An all solid secondary battery according to the present invention includes a positive electrode layer, a solid electrolyte layer including a solid electrolyte, and a negative electrode layer. At least one of the positive electrode layer and the negative electrode layer, and the solid electrolyte layer are joined by sintering. At least one of the positive electrode layer and the negative electrode layer includes an electrode active material, and a conductive agent containing a carbon material. The carbon material has a specific surface area of 1000 m²/g or less.

In the all solid secondary battery according to the present invention, the carbon material preferably has an average particle diameter of 0.5 μm or less.

In addition, in the all solid secondary battery according to the present invention, at least one of the solid electrolyte and the electrode active material preferably includes a lithium containing phosphate compound.

Furthermore, in the all solid secondary battery according to the present invention, the solid electrolyte preferably includes a NASICON-type lithium containing phosphate compound.

A method for manufacturing the all solid secondary battery according to the present invention includes the following steps:

(A) a slurry preparation step of preparing each slurry for a positive electrode layer, a solid electrolyte layer, and a negative electrode layer;

(B) a green sheet forming step of shaping each slurry for the positive electrode layer, the solid electrolyte layer, and the negative electrode layer to prepare green sheets;

(C) a laminated body forming step of stacking the respective green sheets for the positive electrode layer, the solid electrolyte layer, and the negative electrode layer to form a laminated body; and

(D) a firing step of subjecting the laminated body to sintering.

In the slurry preparation step, at least one slurry for the positive electrode layer or the negative electrode layer includes an electrode active material, and a conductive agent containing a carbon material which has a specific surface area of 1000 m²/g or less.

In the slurry preparation step of the method for manufacturing an all solid secondary battery according to the present invention, at least one slurry for the positive electrode layer or the negative electrode layer includes an electrode active material, and a conductive agent containing a carbon material which has an average particle diameter of 0.5 μm or less.

In addition, in the slurry preparation step of the method for manufacturing an all solid secondary battery according to the present invention, each slurry for the positive electrode layer, the solid electrolyte layer, and the negative electrode layer preferably includes a polyvinyl acetal resin as a binder.

Furthermore, in the method for manufacturing an all solid secondary battery according to the present invention, the firing step preferably includes a first firing step of heating the laminated body to remove the binder, and a second firing step of joining at least one of the positive electrode layer and the negative electrode layer to the solid electrolyte layer by firing.

In the method for manufacturing an all solid secondary battery according to the present invention, the laminated body is preferably heated at a temperature of 400° C. or more and 600° C. or less in the first firing step.

The use of the carbon material which has a specific surface area of 1000 m²/g or less for the conductive agent is believed to make it possible to suppress burning of the carbon material in the firing step of removing an organic material such as the binder, and the ratio of the carbon material remaining in the electrode layer (positive electrode layer or negative electrode layer) can be thus increased. This increased ratio makes it possible to achieve the full effect of the conductive agent providing the electrode layer with electron conductivity, even when the electrode layer and the solid electrolyte layer are joined by sintering.

### BRIEF EXPLANATION OF THE DRAWINGS

FIG. 1 is a cross-sectional view schematically illustrating a cross-section structure of an all solid secondary battery as an embodiment of the present invention.

FIG. 2 is a perspective view schematically illustrating an all solid secondary battery as an embodiment of the present invention.

FIG. 3 is a perspective view schematically illustrating an all solid secondary battery as another embodiment of the present invention.

### DETAILED DESCRIPTION OF THE INVENTION

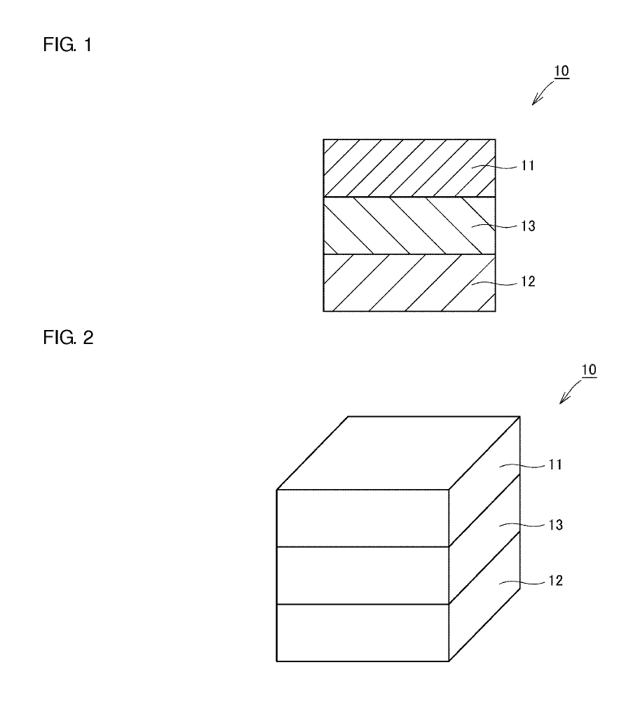

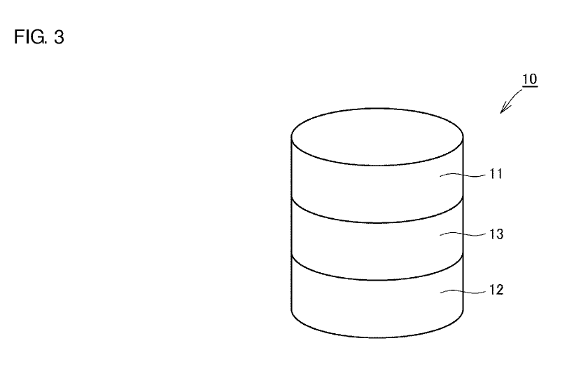

As shown in FIG. 1, an all solid secondary battery 10 according to the present invention includes a positive electrode layer 11, a solid electrolyte layer 13 including a solid electrolyte, and a negative electrode layer 12. As shown in FIG. 2, an all solid secondary battery 10 as an embodiment of the present invention is formed to have a rectangular parallelepiped shape, and composed of a laminated body including multiple plate-shaped layers which have a rectangular plane. In addition, as shown in FIG. 3, an all solid secondary battery 10 as another embodiment of the present invention is formed to have a cylindrical shape, and composed of a laminated body including multiple disk-shaped layers.

At least one of the positive electrode layer 11 and the negative electrode layer 12, and the solid electrolyte layer 13 are joined by sintering. At least one of the positive electrode layer 11 and the negative electrode layer 12 includes an electrode active material, and a conductive agent containing a carbon material. The carbon material has a specific surface area of 1000 m²/g or less.

The carbon material as a conductive agent, added to the electrode active material as described above, has a specific surface area of 1000 m²/g or less, and it is thus believed that the adsorption of an oxygen gas on the carbon material can be suppressed in the firing step of removing an organic material such as the binder, and as a result, burning of the carbon material can be suppressed. This suppression increases the residual ratio of the carbon material, thereby causing the carbon material to efficiently function as a conductive agent in the electrode layer. Therefore, the increased ratio makes it possible to achieve the full effect of the conductive agent providing the electrode layer with electron conductivity, even when the electrode layer and the solid electrolyte layer are joined by sintering. It is to be noted that the specific surface area of the carbon material preferably has a lower limit of 1 m²/g. The specific surface area of the carbon material less than 1 m²/g may fail to achieve sufficient electron conductivity.

In a preferred embodiment of the all solid secondary battery according to the present invention, the carbon material for use as a conductive agent has an average particle size of 0.5 μm or less. The use of the carbon material with an average particle size of 0.5 μm or less can efficiently achieve the effect of the carbon material providing the electrode layer with electron conductivity. It is to be noted that the average particle size of the carbon material has a lower limit of 0.01 μm. The average particle size of the carbon material less than 0.01 μm may fail to achieve sufficient electron conductivity.

In the all solid secondary battery according to the present invention, a lithium containing phosphate compound which has a NASICON structure, a lithium containing phosphate compound which has an olivine structure, a lithium containing spinel compound including a transition metal such as Co, Ni, or Mn, a lithium containing layered compound, etc. can be used as the electrode active material. As the solid electrolyte, a lithium containing phosphate compound which has a NASICON structure, an oxide solid electrolyte which has a perovskite structure such as La_{0.55}Li_{0.35}TiO₃, an oxide solid electrolyte which has a garnet structure such as Li₇La₃Zr₂O₁₂ or a similar structure to the garnet type, etc. can be used.

In a preferred embodiment of the all solid secondary battery according to the present invention, the solid electrolyte and the electrode active material include a lithium containing phosphate compound such as a lithium containing phosphate compound which has a NASICON structure or a lithium containing phosphate compound which has an olivine structure. As described above, the solid electrolyte and the electrode active material are both composed of a material which has a phosphate anion skeleton, and the electrode layer and the solid electrolyte layer can be thus joined closely by sintering in the firing step.

In the method for manufacturing an all solid secondary battery according to the present invention, first, each slurry is prepared for the positive electrode layer, the solid electrolyte layer, and the negative electrode layer. In this case, the slurry is prepared in such a way that at least one slurry for the positive electrode layer or the negative electrode layer includes an electrode active material, and a conductive agent including a carbon material which has a specific surface area of 1000 m²/g or less. Next, for each of the positive electrode layer, the solid electrolyte layer, and the negative electrode layer, the slurry is shaped to prepare green sheets. Then, the respective green sheets for the positive electrode layer, the solid electrolyte layer, and the negative electrode layer are stacked to form a laminated body. After that, the laminated body is subjected to sintering.

In the slurry preparation step of the method for manufacturing an all solid secondary battery according to the present invention, at least one slurry for the positive electrode layer or the negative electrode layer includes an electrode active material, and a conductive agent containing a carbon material which has an average particle diameter of 0.5 μm or more.

In addition, in the slurry preparation step of the method for manufacturing an all solid secondary battery according to the present invention, common resins such as polyvinyl acetal resins, e.g., a polyvinyl butyral resin, celluloses, acrylic resins, urethane resins, etc. can be used as the binder included in each slurry for the positive electrode layer, the solid electrolyte layer, and the negative electrode layer. Among these resins, the polyvinyl butyral resin is preferably used as the binder. The use of the polyvinyl butyral resin as the binder makes it possible to manufacture a green sheet which has a high mechanical strength and has less peeling or lack.

Furthermore, in the method for manufacturing an all solid secondary battery according to the present invention, the firing step preferably includes a first firing step of heating the laminated body to remove the binder, and a second firing step of joining at least one of the positive electrode layer and the negative electrode layer to the solid electrolyte layer by firing. In this case, the laminated body is preferably heated at a temperature of 400° C. or more and 600° C. or less in the first firing step.

Next, examples of the present invention will be described specifically. It is to be noted that the examples shown below are just examples, and the present invention is not to be considered limited to the following examples.

### EXAMPLES

Examples 1 to 10 and Comparative Examples 1 to 2 of all solid secondary batteries will be described below which were prepared with the use of various types of carbon materials as the conductive agent added to the electrode active material.

First, the various types of carbon material powders used as the conductive agent were evaluated for their properties in the following way.

(Evaluation of Carbon Material Powder for Conductive Agent)

Commercially available carbon material powders A to F used were evaluated for the following properties (1) to (3).

(1) Specific Surface Area [m²/g]

For the carbon material powders A to F, a multi-sample specific surface area measuring apparatus (Multisoap from Yuasa Ionics Co., Ltd.) was used to measure the specific surface areas by BET method. Table 1 shows the specific surface areas of the carbon material powders A to F.

(2) Average Particle Size (D₅₀) [μm]

For the carbon material powders A to F, a particle size analysis measurement apparatus (Microtrack HRA from NIKKISO CO., LTD.) was used to measure the average particle sizes D₅₀ by a laser diffraction and scattering method. Table 1 shows the D₅₀ for the carbon material powders A to F.

(3) Mass Loss Temperature [° C.]

For the carbon material powders A to F, a differential-type differential thermal balance (TG-DTA) (Model Number: TG-DTA 2020SA) from Bruker AXS K.K. was used to measure the mass loss temperatures. The differential thermal analysis was carried out under the condition of a rate of temperature increase of 3° C./min in an air atmosphere with a flow rate of 300 ccm, and the temperature was read off at which mass loss was started. Table 1 shows the mass loss temperature for the carbon material powders A to F.

TABLE 1

| Type of | Specific | Average | |
|---|---|---|---|
| Carbon | Surface | Particle | Mass Loss |
| Material | Area | Size | Temperature |
| Powder | [m²/g] | D₅₀ [μm] | [° C.] |
| A | 1357 | 0.2 | 500 |
| B | 800 | 0.2 | 530 |
| C | 133 | 0.3 | 540 |
| D | 63 | 0.1 | 550 |
| E | 72 | 0.2 | 600 |
| F | 21 | 5.3 | 640 |

From the results shown in Table 1, it is determined that as the specific surface area of the carbon material powder is decreased, the mass loss temperature thereof is increased.

Next, the respective carbon material powders evaluated above were used as the conductive agent to prepare electrode material powders in the following way.

(Preparation of Electrode Material Powder)

Electrode material powders A to F were prepared in the following way, which were composed of a lithium containing phosphate compound Li₃V₂(PO₄)₃ (hereinafter, referred to as LVP) including a NASICON structure as the electrode active material, and of the carbon material powders A to F evaluated above as the conductive agent respectively.

Lithium carbonate (Li₂CO₃), vanadium pentoxide (V₂O₅), and ammonium phosphate dibasic ((NH₄)₂HPO₄) were used as starting raw materials. These raw materials were weighed at a predetermined molar ratio so as to provide Li₃V₂(PO₄)₃ as a result, and mixed in a mortar to provide mixed powders. The mixed powders obtained were subjected to firing at a temperature of 600° C. in an air atmosphere for 10 hours to obtain a precursor powder for LVP.

Next, the obtained precursor powder for LVP with each of the carbon material powders A to F added as the conductive agent so as to provide LVP:carbon=19:1 in terms of ratio by weight, were then subjected to firing at a temperature of 950° C. for 10 hours in an argon gas atmosphere, thereby preparing electrode material powders.

In addition, a solid electrolyte material powder was prepared in the following way.

(Preparation of Solid Electrolyte Material Powder)

As the solid electrolyte, a lithium containing phosphate compound Li_{1.5}Al_{0.5}Ge_{1.5}(PO₄)₃ (hereinafter, referred to as a LAGP) powder including a NASICON structure was prepared in accordance with the following procedure.

Lithium carbonate (Li₂CO₃), aluminum oxide (Al₂O₃), germanium oxide (GeO₂), and phosphoric acid (H₃PO₄) were used as starting raw materials. These raw materials were weighed at a predetermined molar ratio so as to provide Li_{1.5}Al_{0.5}Ge_{1.5}(PO₄)₃ as a result, and mixed in a mortar to provide mixed powders. The mixed powders obtained were heated at a temperature of 1200° C. for 5 hours in an air atmosphere to obtain a melted product. The melted product obtained was added dropwise into flowing water to prepare a LAGP glass powder. The obtained glass powder was subjected to firing at a temperature of 600° C. to prepare a solid electrolyte material powder composed of LAGP.

Next, the electrode material powders A to F and the solid electrolyte material powder obtained above were used to prepare electrode sheets A to F and a solid electrolyte sheet as compacts for characteristic evaluation in the following way.

(Preparation of Electrode Slurry and Solid Electrolyte Slurry)

As the binder, a polyvinyl butyral resin (PVB) was dissolved in ethanol to prepare a binder solution. The respective electrode material powders A to F, the solid electrolyte material powder, and the binder solution prepared above were weighed so as to provide electrode material:solid electrolyte:PVB=40:40:20 in terms of ratio by weight, and mixed to obtain electrode slurries A to F.

The solid electrolyte material powder and the binder solution prepared above were weighed so as to provide solid electrolyte:PVB=80:20 in terms of ratio by weight, and mixed to obtain a solid electrolyte slurry.

(Preparation of Electrode Sheet and Solid Electrolyte Sheet as Compacts)

The obtained electrode slurries A to F and solid electrolyte slurry were each formed by a doctor blade method into the shape of a sheet with a thickness of 10 μm to prepare electrode green sheets A to F and a solid electrolyte green sheet. The obtained electrode green sheets A to F and solid electrolyte green sheet were subjected to firing at a temperature of 500° C. for 2 hours in an air atmosphere, thereby removing the PVB. In this way, the electrode sheets A to F and solid electrolyte sheet were prepared as compacts.

The obtained electrode sheets A to F and solid electrolyte sheet were evaluated for their characteristics in the following way.

(Evaluation of Sheet)

Table 2 shows the weights [mg] of the electrode sheets A to F and the solid electrolyte sheet before and after the removal of the PVB (before and after firing), the weight loss rate [weight %] thereof, and residual carbon ratio [weight %] thereof after the removal of the PVB (after firing).

In this case, the residual carbon ratio refers to weight % for carbon remaining after the removal of the PVB. On the basis of the composition of each slurry, the residual carbon ratio was calculated in accordance with the following formula.

(Residual Carbon Ratio [weight %])=100−[{(Weight Loss Rate [weight %])−20}/2×100]

In the calculation formula, the value “20” in the formula refers to weight % for the binder PVB included in each slurry, and the value “2” refers to weight % for carbon included in each slurry.

The calculation formula is based on the following grounds.

First, when the solid electrolyte sheet is subjected to firing at a temperature of 500° C., the weight loss rate is substantially 20 weight % as shown in Table 2. For this reason, it is assumed that the firing at a temperature of 500° C. removes all of the binder included in each slurry at the ratio of 20 weight %.

Next, the weight loss rate is expressed in the following formula.

(Weight Loss Rate [weight %])=(Binder included in Slurry [weight %])+(Burned Carbon [weight %])

From the above formula, the burned carbon [weight %] is expressed in the following formula.

(Burned Carbon [weight %])=(weight Loss Rate [weight %])−(Binder included in Slurry [weight %])

Therefore, the residual carbon ratio is calculated in the following way.

(Residual Carbon Ratio [weight %])=100−[(Burned Carbon [weight %])/(Carbon included in Slurry [weight %])×100]=100−[{(Weight Loss Rate [weight %])−(Binder included in Slurry [weight %])}/(Carbon included in Slurry [weight %])×100]=100−[{(Weight Loss Rate [weight %])−20}/2×100]

TABLE 2

| | Weight | Weight | Weight Loss | Residual |
|---|---|---|---|---|
| | Before | After | Rate | Carbon Ratio |
| Sheet Type | Firing [mg] | Firing [mg] | [weight %] | [weight %] |
| Electrode | 155.6 | 121.7 | 21.8 | 11 |
| Sheet A | | | | |
| Electrode | 145.6 | 114.8 | 21.2 | 42 |
| Sheet B | | | | |
| Electrode | 147.0 | 116.7 | 20.6 | 69 |
| Sheet C | | | | |
| Electrode | 147.3 | 117.0 | 20.6 | 71 |
| Sheet D | | | | |
| Electrode | 151.5 | 120.7 | 20.3 | 83 |
| Sheet E | | | | |
| Electrode | 147.3 | 117.4 | 20.3 | 85 |
| Sheet F | | | | |
| Solid | 193.8 | 154.7 | 20.2 | — |
| Electrolyte | | | | |
| Sheet | | | | |

From the results shown in Table 2, it is determined the carbon material powder A is mostly burned in the case of the electrode sheet A, whereas about half or more the carbon material powders B to F remain in the case of the electrode sheets B to F. It is to be noted that the weight loss ratio of the solid electrolyte sheet is 20.1 weight %, which gives close agreement with the weight % for the PVB contained in the slurry composition. Thus, the firing at a temperature of 500° C. for 2 hours in an air atmosphere generally removed the binder PVB in the solid electrolyte sheet.

In the following way, the electrode slurry A and the solid electrolyte slurry prepared above were used to prepare an all solid secondary battery according to Comparative Example 1, and each of the electrode slurries B to F and the solid electrolyte slurry were used to prepare solid batteries according to Examples 1 to 5.

### Preparation of Solid Batteries according to Comparative Example 1 and Examples 1 to 5

From the solid electrolyte slurry prepared above, solid electrolyte sheets were formed by uniaxial pressing through cutting into a circular shape of 1 mm in thickness and 13 mm in diameter. In addition, from each of the electrode slurries A to F prepared above, electrode sheets A1 to F1 were each formed by uniaxial pressing through cutting into a circular shape of 1 mm in thickness and 12 mm in diameter. Each of the electrode sheets A1 to F1 was subjected once to thermocompression bonding at a temperature of 80° C. onto one side of the obtained solid electrolyte sheet, whereas each of the electrode sheets A1 to F1 was subjected twice to thermocompression bonding at a temperature of 80° C. onto the other side of the solid electrolyte sheet, thereby preparing laminated bodies for solid batteries.

The obtained laminated bodies for solid batteries were subjected to firing at a temperature of 500° C. for 2 hours in an air atmosphere to carry out the removal of the PVB. After that, the laminated bodies for solid batteries were subjected to firing at a temperature of 750° C. for 1 hour in an argon gas atmosphere to join the electrode layers and the solid electrolyte layers by sintering.

The laminated bodies for solid batteries, which had been subjected to joining by sintering, were dried at a temperature of 100° C. to remove moisture. Next, while using the sides with each of the electrode sheets A1 to F1 subjected once to thermocompression bonding as positive electrodes and the sides with each of the electrode sheets A1 to F1 subjected twice to thermocompression bonding as negative electrodes, the laminated bodies were encapsulated into 2032-type coin cells to prepare solid batteries.

The obtained solid batteries were evaluated for their characteristics in the following way.

(Evaluation of Solid Battery)

The solid batteries according to Comparative Example 1 and Examples 1 to 5 were subjected to voltage scan at a speed of 0.1 mV/second in a voltage range of 0 to 4 V to measure the charging capacity and the discharging capacity. The results are shown in Table 3.

TABLE 3

| | | | Charge/ |
|---|---|---|---|
| | Charging | Discharging | Discharge |
| Solid Battery | Capacity | Capacity | Efficiency |
| Number | [mAh/g] | [mAh/g] | [%] |
| Comparative | 2 | 0.3 | 15.0 |
| Example 1 | | | |
| (Electrode | | | |
| Sheet A1) | | | |
| Example 1 | 61 | 37 | 60.7 |
| (Electrode | | | |
| Sheet B1) | | | |
| Example 2 | 69 | 44 | 63.8 |
| (Electrode | | | |
| Sheet C1) | | | |
| Example 3 | 74 | 49 | 66.2 |
| (Electrode | | | |
| Sheet D1) | | | |
| Example 4 | 74 | 50 | 67.6 |
| (Electrode | | | |
| Sheet E1) | | | |
| Example 5 | 38 | 17 | 44.7 |
| (Electrode | | | |
| Sheet F1) | | | |

From the results shown in Table 3, it is determined that, as compared with the solid battery according to Comparative Example 1 using the carbon material powder A as the conductive agent of the electrode material, the solid batteries according to Examples 1 to 5 using the carbon material powders B to F as the conductive agent of the electrode material are higher in terms of charge/discharge capacity, and in particular, the solid batteries according to Examples 1 to 4 are high in terms of charge/discharge capacity. This is believed to be because, in the case of the solid battery according to Comparative Example 1 using the carbon material powder A with a specific surface area of 1000 m²/g or more, the carbon material is burned to reduce the effect of providing the electrode layer with electron conductivity, thereby as a result, making it impossible to make full use of the active material in the electrode layer, and thus leading to a decrease in charge/discharge capacity. In contrast to this example, it is believed that the solid battery according to Example 5 using the carbon material powder F with a specific surface area of 1000 m²/g or less but with a larger average particle size, has the carbon material powder with a larger average particles size, as compared with the solid batteries according to Examples 1 to 4 using the carbon material powders B to E with a smaller specific surface area and with a smaller average particle size, thus failing to obtain electron conductivity efficiently, and thereby as a result, making it impossible to make full use of the active material.

### Preparation of Solid Batteries according to Comparative Example 2 and Examples 6 to 10

Solid batteries according to Comparative Example 2 and Examples 6 to 10 were prepared in the same way as in the case of the solid batteries according to Comparative Example 1 and Examples 1 to 5, except that a lithium containing phosphate compound LiFe_{0.5}Mn_{0.5}PO₄ (hereinafter, referred to as an LFMP) including an olivine structure was used as the electrode active material. Further, electrode materials G to L were prepared in the following way, for use in each of the solid batteries according to Comparative Example 2 and Examples 6 to 10.

(Preparation of Electrode Material Powder)

Electrode material powders G to L composed of an LFMP powder as the electrode active material and of each of the carbon material powders A to F evaluated above as the conductive agent were prepared in the following way.

Lithium carbonate (Li₂CO₃), iron oxide (Fe₂O₃), manganese oxide (MnCO₃), and ammonium lithium vanadium phosphate (NH₄Li₃V₂(PO₄)₃) were used as starting raw materials. These raw materials were weighed at a predetermined molar ratio so as to provide LiFe_{0.5}Mn_{0.5}PO₄ as a result, and mixed in a mortar to provide mixed powders. The mixed powders obtained were subjected to firing at a temperature of 500° C. for 10 hours in an argon gas atmosphere to obtain a precursor powder for LFMP.

Next, the obtained precursor powder for LFMP with each of the carbon material powders A to F added as the conductive agent so as to provide LFMP:carbon=19:1 in terms of ratio by weight, were then subjected to firing at a temperature of 700° C. for 10 hours in an argon gas atmosphere, thereby preparing electrode material powders G to L. Next, the solid batteries according to Comparative Example 2 and Examples 6 to 10 were prepared in the same way as in the method for manufacturing the solid batteries according to Comparative Example 1 and Examples 1 to 5.

The obtained solid batteries were evaluated for their characteristics in the following way.

(Evaluation of Solid Battery)

The solid batteries according to Comparative Example 2 and Examples 6 to 10 were subjected to voltage scan at a speed of 0.1 mV/second in a voltage range of 0 to 4 V to measure the charging capacity and the discharging capacity. The results are shown in Table 4.

TABLE 4

| | | | Charge/ |
|---|---|---|---|
| | Charging | Discharging | Discharge |
| Solid Battery | Capacity | Capacity | Efficiency |
| Number | [mAh/g] | [mAh/g] | [%] |
| Comparative | 3 | 1 | 33.3 |
| Example 2 | | | |
| (Electrode | | | |
| Material G) | | | |
| Example 6 | 66 | 41 | 62.1 |
| (Electrode | | | |
| Material H) | | | |
| Example 7 | 73 | 50 | 68.5 |
| (Electrode | | | |
| Material I) | | | |
| Example 8 | 81 | 59 | 72.8 |
| (Electrode | | | |
| Material J) | | | |
| Example 9 | 85 | 65 | 76.5 |
| (Electrode | | | |
| Material K) | | | |
| Example 10 | 40 | 21 | 52.5 |
| (Electrode | | | |
| Material L) | | | |

From the results shown in Table 4, it is determined that, as compared with the solid battery according to Comparative Example 2 using the carbon material powder A as the conductive agent of the electrode material, the solid batteries according to Examples 6 to 10 using the carbon material powders B to F as the conductive agent of the electrode material are higher in terms of charge/discharge capacity, and in particular, the solid batteries according to Examples 6 to 9 are high in terms of charge/discharge capacity.

From the results described above, in order to achieve the full effect of the conductive agent providing the electrode layer with electron conductivity, the carbon material for use as the conductive agent of the electrode material needs to have a specific surface area of 1000 m²/g or less, and furthermore, the average particle size of the carbon material is preferably 0.5 μm or less.

It is to be noted that while the cases of preparing, as an electrode material, a mixture of the electrode active material and the carbon material by adding the carbon material as the conductive agent to the electrode active material have been described in the examples, the timing of the addition of the carbon material is not limited to the step of preparing the electrode material. For example, even in the case of preparing an electrode material from only the electrode active material without adding the carbon material and of adding the carbon material to the electrode material in the preparation of an electrode slurry, the effect of the present invention can be also achieved. In addition, the effect of the present invention can be also achieved in such a case of further adding the carbon material to a slurry including a mixture of an electrode active material and the carbon material.

The embodiments and examples disclosed herein are to be considered by way of example in all respects, but not limiting. The scope of the present invention is defined by the claims, but not by the embodiments or examples described above, and intended to encompass all modifications and variations within the spirit and scope equivalent to the claims.

Even in the case of using an electrode material obtained by adding a carbon material as a conductive agent to an electrode active material, and joining an electrode layer and a solid electrolyte layer by sintering, an all solid secondary battery can be provided which is capable of achieving the full effect of the conductive agent providing the electrode layer with electron conductivity.

### DESCRIPTION OF REFERENCE SYMBOLS

10: all solid secondary battery

11: positive electrode layer

12: negative electrode layer

13: solid electrolyte layer

1. A solid battery comprising:
a positive electrode layer;
a solid electrolyte layer including a solid electrolyte; and
a negative electrode layer,
wherein at least one of the positive electrode layer and the negative electrode layer includes an electrode active material and a carbon material, the carbon material having a specific surface area of 1000 m²/g or less.

2. The solid battery according to claim 1, wherein the carbon material has an average particle diameter of 0.5 μm or less.

3. The solid battery according to claim 2, wherein the average particle diameter is from about 0.01 μm to 0.5 μm.

4. The solid battery according to claim 1, wherein the specific surface area of the carbon material is from about 1 m²/g to 1000 m²/g.

5. The solid battery according to claim 1, wherein at least one of the solid electrolyte and the electrode active material includes a lithium containing phosphate compound.

6. The solid battery according to claim 5, wherein the solid electrolyte and the electrode active material include a lithium containing phosphate compound.

7. The solid battery according to claim 5, wherein the lithium containing phosphate compound is a NASICON-type lithium containing phosphate compound.

8. The solid battery according to claim 1, wherein the electrode active material is a lithium containing compound.

9. The solid battery according to claim 8, wherein the lithium containing compound is selected from the group consisting of lithium containing phosphate compounds having a NASICON structure, lithium containing phosphate compounds having an olivine structure, lithium containing spinel compounds having a transition metal, and lithium containing layered compounds.

10. The solid battery according to claim 1, wherein the solid electrolyte is a lithium containing compound.

11. The solid battery according to claim 10, wherein the lithium containing compound is selected from the group consisting of lithium containing phosphate compounds having a NASICON structure, oxide solid electrolytes having a perovskite structure, and oxide solid electrolytes having a garnet structure.

12. The solid battery according to claim 1, wherein at least one of the positive electrode layer and the negative electrode layer is joined to the solid electrolyte layer by sintering.

13. A solid battery comprising:
at least one electrode layer including an electrode active material and a carbon material having a specific surface area of 1000 m²/g or less; and
a solid electrolyte layer adjacent the at least one electrode layer, the solid electrolyte including a solid electrolyte,
wherein the carbon material is sized so as to suppress burning of the carbon material during a sintering process such that a residual ratio of the carbon material after the sintering process is sufficient to provide electrode conductivity between the at least one electrode layer and the solid electrolyte layer.

14. A method for manufacturing a solid battery, the method comprising:
preparing a positive electrode layer slurry, a solid electrolyte layer slurry, and a negative electrode layer slurry;
shaping the positive electrode layer slurry, the solid electrolyte layer slurry, and the negative electrode layer slurry into respective positive electrode layer, solid electrolyte layer, and the negative electrode layer green sheets;
stacking the respective green sheets to form a laminated body; and
firing the laminated body,
wherein at least one of the positive electrode layer slurry and the negative electrode layer slurry includes an electrode active material and a carbon material having a specific surface area of 1000 m²/g or less.

15. The method for manufacturing a solid battery according to claim 14, wherein the carbon material has an average particle diameter of 0.5 μm or less.

16. The method for manufacturing a solid battery according to claim 14, wherein the positive electrode layer slurry, the solid electrolyte layer slurry, and the negative electrode layer slurry include a polyvinyl acetal resin.

17. The method for manufacturing a solid battery according to claim 14, wherein the step of firing the laminated body includes a first firing step of heating the laminated body to remove a binder, and a second firing step to join at least one of the positive electrode layer green sheet and the negative electrode layer green sheet to the solid electrolyte layer green sheet.

18. The method for manufacturing a solid battery according to claim 17, wherein the laminated body is heated at a temperature of 400° C. or more and 600° C. or less in the first firing step.
